(19) United States
(12) Patent Application Publication
(10) Pub. No.: US 2015/0248413 A1
(43) Pub. Date: Sep. 3, 2015

(54) Learning Quotient & Scoring Systems and Methods for Competency and Learning Progression

(71) Applicant: Sanje Pershad Ratnavale, San Francisco, CA (US)

(72) Inventor: Sanje Pershad Ratnavale, San Francisco, CA (US)

(21) Appl. No.: 14/610,978

(22) Filed: Jan. 30, 2015

Related U.S. Application Data
(60) Provisional application No. 61/934,520, filed on Jan. 31, 2014.

(51) Int. Cl. G06F 17/30; G09B 5/00

(52) U.S. Cl. CPC G06F 17/3053; G09B 5/00; G06F 17/30011; G06F 17/3082; G06F 17/30864

(57) ABSTRACT

The present invention is directed to systems and methods for implementing a learning management system and contextualizing educational content based on personalized relevance. The invention looks at learning management as not simply an assessment delivery and determination model fed at summative intervals, but rather as a real-time process with indicators that are data-driven, contextual, progressive, and interactive. The invention thus provides a system, method and framework for providing incremental and continuous analytics of competency or regression, content relevance accessed or classified, and course sequence suitability in order to measure relevant time, rate progress, personalize pathways and optimize educational success and opportunity.

### CROSS-REFERENCE TO RELATED APPLICATIONS

This application is related to and applicant claims priority from U.S. provision application No. 61/934,520, filed Jan. 31, 2014, titled “Learning Quotient & Scoring Systems and Methods for Competency and Learning Progression”, and listing inventor Sanje Pershad Ratnavale, which is incorporated by reference herein.

### BACKGROUND OF THE INVENTION

The ways in which individuals and organizations learn are diverse, disparate and complex. Currently, the educational system relies heavily on formulaic instruction and testing conducted at summative intervals. This has been largely a function of the economical need to enable students to be evaluated and taught in batches—such as a class of 20 students taught and evaluated in an identical fashion by one teacher. Even the widely used term “Standard” has connotations of achievement rather than progression, as opposed to the more fluid, incremental notion of “competency”. Consequently, neither instruction nor the assessment of learning progression is personalized, real-time or continuous.

Assessing learning on a competency-based approach has also been impeded by the lack of agreement on the essential elements of a course, unit or standard because education systems have been highly protective of local autonomy in deciding such matters. Even where nations or large areas have agreed on a national curriculum (such as the Common Core Standards), it is rare that the definitions of standards are narrow enough, for example, to pinpoint where a student relocating geographically should be placed in a course of study when arriving at a new school. A more granular taxonomy-extending below and within standards to the underlying hierarchical bases comprising standards—is required.

The advent of online learning has begun to address this need and shifted focus from time-based models. However, online learning, particularly in the K-12 world, is still forced to follow assessment and grading practices. In the college world, MOOCs (massively open online courses), where thousands of students from different countries can concurrently take courses from top colleges, allow students to complete the course elements in an order of their choice, often achieving better results and a better learning experience principally because the sequence is flexible and more individualized. The online experience at all levels, and the concomitant liberalization of content and empowerment of the student with flexible structuring and course-element sequence suggests new means to assess competency and capture, track, analyze and simulate learning are required.

Learning takes place at home and at school. One intractable problem is matching the effort and success at home with work and instruction done at school. Homework has, therefore, been an area where assessment of competency is downgraded to a mere score. In some societies and countries, homework has great importance placed on it, but in others it is frowned upon as an indicator of a teacher's inability to provide the whole class with the required instruction and is perceived as teacher failure.

With the growth of blended models of learning, such as the flipped classroom where the teacher delivers content in video to be seen at home and then works with students while they do work in class to provide closer attention, the lines between home and school are now blurring further. Online students do all their work at home. Homework that is validated, provides a real measure of competency, and is valued and trusted as a yardstick of time dedicated to mastering subject matter would be ideal. Homework is sometimes scored by teachers based on achievement and at other times based on apparent effort. Ideally a tool that captures these elements would enable teachers to provide greater motivation for the completion of homework and at the same time provide useful data on its effect.

The bulwarks of the current educational structure, viz., the textbook publishers, have sought to personalize learning with solutions that only perpetuate past practices. As they confront the disappearance of print textbooks and the concomitant revenue loss, textbook publishers are to make their digital content appear “more intelligent,” but have only succeeded in bundling expensive adaptive learning features to their content that is still designed for batch processing of students. For example, a publisher will sell a school a digital textbook that delivers new assessments to a student based on the student's online work. The problem with this approach is that the homework and formative assessments are really the remit of the teacher rather than some artificially intelligent textbook. Ideally, a teacher would be able to assess competency and monitor student progress and provide differentiated instruction that is regularly adjusted, calibrated and integrated across all courses to achieve overall curriculum objectives. The huge demands on a teacher make this an impossible goal and one that is even more confounded by the lack of funds of schools to integrate all their systems. Recent approaches have tried to even create a massive student clearing house of all data that provides an integrated safe analytical layer for all schools in the US. This non-profit initiative has faded with most early adopters pulling out as a result of privacy concerns.

Instead of developing and utilizing systems that provide real-time assessment of competency, measures of student progress, and differentiated instruction that is regularly adjusted, calibrated and integrated for each student, educators are increasingly being pushed into “alignment” strategies and “assessment heavy” evaluation regimes to cope with large class sizes that take away their ability to gauge competency at an individual level or provide differentiation. Teachers seeking to construct a new course or even simply modify it at the margins are constrained by a lack of autonomy and efficient and economical access to proven relevant and effective course design materials. Creating a course in these circumstances leads educators to miss opportunities to institute best practices in the field, borrow techniques proven to be effective in related fields, and present the best content to students. Courses are often too challenging for many students or are “dumbed down” to meet the needs of the student with lowest level of achievement while holding back higher achievers. Educators who seek to improve existing courses are similarly constrained by a lack of statistically granular student assessment and learning progression data indicating which changes to a course would be most beneficial for a particular student.

The Intelligence Quotient (IQ) is a measure of intelligence in people. While IQ may be a predictor of achievement, it does not carry with it any heuristic information related to how best the student learns. Two students with identical IQs may perform radically differently in the same course. IQ also tells nothing about the student's historical learning progression, completion of coursework, and level of mastery of various topics. IQ is too compact a statistic to meaningfully inform construction of a course, even on an individualized level.

Personalized learning systems (“PLS”) seek to individualize a student's learning. Ideally, each student has materials presented to them only when and to the extent needed, and in a sequence that optimizes that student's learning based on holistic benchmarks of knowledge, skills, and abilities across subjects and across predefined standards of progression in a course. Thus, there is a need for a more robust system to capture and evaluate useful data on learning progression, inform the teacher and student about the possible structure of present and future courses, enable the teacher to improve courses, and maximize the utility of content presented to the student.

A related issue facing students and educators alike is the difficulty in discovering and assessing learning-enabling content. Students face challenges finding relevant content that is new to them while researching assignments. Research has shown that students learn differently and have specific preferences as to types of content, for example visual or auditory content may be preferences. Educators face challenges in finding and incorporating into courses the suitable content that most effectively enables each and every learning objective for the course. Educators also face challenges in assessing whether students' written work demonstrates mastery of these learning objectives. Both educators and students must locate, consume, and comprehend the content to determine if it is relevant to the assignment, all while considering that instructive usefulness of other available content. What is helpful to one student based on his learning history may not be helpful to another student who has progressed further in her learning, or may be helpful but only if consumed in a different sequence. Likewise, what is helpful to one educator designing a course may not be helpful to another who knows her students have not taken a certain pre-requisite.

Existing systems also do not allow for the customized discovery, tagging, linking, indexing, and delivery of content based on a student's personal learning history. Educators are left guessing as to whether the content they find, if and when they find it, is appropriate for their courses and students, because the PLS itself cannot contextualize content. Existing content contextualization systems, used in other fields such as search engine optimization, look at links between documents and the relative emphases and meaning of words in bodies of texts, based on a conceptual dictionary, but present a limited array of tag options and are not indexed in such a way as to allow educators to identify the best application and use of content for a particular student, based on analytics of student performance and the contribution made by the content itself. Existing educational approached do not determine the educational relevance of particular content with an analysis using relevance factors including substantive content and metadata such as tags, content source, content date, collaborative interactive elements. They also do not provide a means by which educators can relate how particular course content comprising a list of reading sources or required videos may contribute to learning progression of particular students.

The tools now exist for educators to actually customize their environments for students. Developments are beginning to change this existing paradigm of learning delivery and evaluation: the advent of online learning; the popularity of MOOCS: the vast liberalization of content and its placement at no cost in the palm of students 24/7; and, most importantly, an always connected Learner population gravitating away from pencils and paper. Thus, there is a need for a PLS that can categorize, contextualize and rank the relevance of content to a particular course of study, and to assess student competency and learning progression.

### BRIEF DESCRIPTION OF THE DRAWINGS

FIG. 1 shows a first embodiment of the system architecture.

FIG. 2 shows a second embodiment of the system architecture.

FIG. 3 shows a preferred embodiment of a LKU taxonomy.

FIG. 4 shows a third embodiment of the system architecture.

FIG. 5 shows a preferred embodiment of the content manager workflow.

FIG. 6 shows a preferred competency framework.

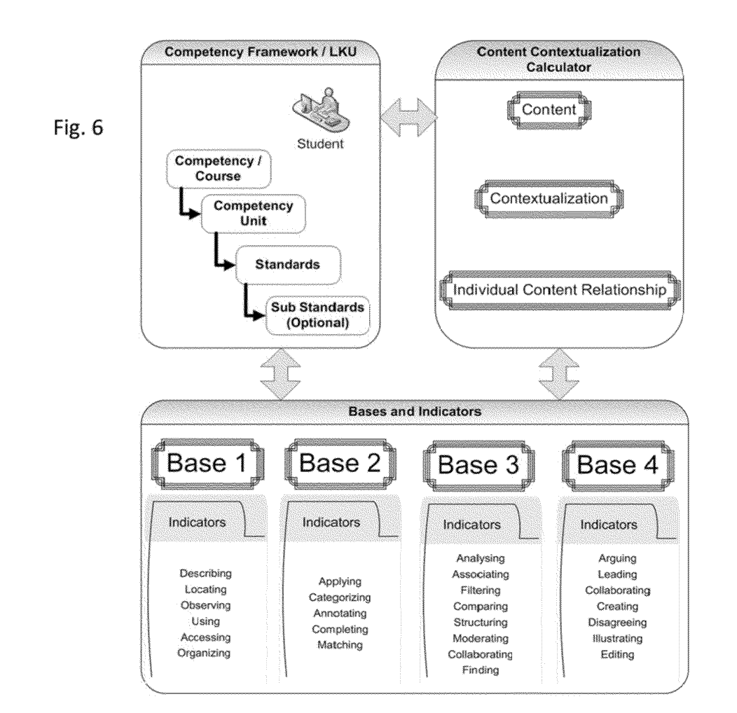

FIG. 7 shows a preferred contextualization workflow.

FIG. 8 shows a preferred individual content workflow.

FIG. 9 shows an exemplary weightage distribution.

FIG. 10 shows an exemplary LKU strand.

### SUMMARY OF INVENTION

The invention disclosed, in certain aspects thereof, comprises systems and methods of scoring, indexing, analyzing, managing and personalizing the learning experience, locating and managing educationally-relevant content, and developing courses. The invention in certain aspects enables educational content to be identified and defined in terms of foundational components or finite elements of various levels which are linked or put together as strands of metadata, each referred to as a learning knowledge unit (“LKU”). LKUs may be associated with educational content in a variety of ways. Preferably, this association is implemented either in a database format, whereby the LKU and the content or a resource locator pointing to the content are stored relationally in a database, or via metadata tagging of the LKU onto the content itself.

In one embodiment of the invention, referred to hereafter as the learning management system (“LMS”), the LMS and its methods use LKUs to identify, categorize and contextualize educational content. LKUs are indicative of certain aspects of the educational relevance of the content, either generally or specific to the particular study area for which the user accesses or creates the content or to himself (if he created it or if he shared it). In this embodiment, LKUs may reveal any or all of the standards, bases, and indicators for which the content has educational value. The content thus may be “contextualized,” for its likelihood of relevance in this embodiment by a “contextualization engine,” and given a contextualization score indicating its relationship, including relevancy and weightage (because the collaborative content may be weighed higher, for example), to a study area. In this embodiment, contextualization may be based on the presence or absence of specific LKUs, or other relevance factors and features of the content such as its source, age, or the substance of the content itself, which indicate directly, indirectly, or via some probability that the content is relevant to a study area, standard, base, or indicator.

LKUs may be associated with a course of study, i.e., a learning plan or curriculum. An educator, in creating a course of study, may use the LMS to create at least one LKU associated with aspects of the course of study. The LMS may use a course LKU as a basis for its contextualization score and relevancy determination functions. This association may be implemented in a variety of ways, preferably in a database format, whereby the LKU and the components of the course of study are stored relationally in a database, or via metadata tagging of the LKU onto the components themselves.

The LMS may utilize contextualization information to validate, time, search for, index, link, rank, sort, highlight, recommend, display, store, deliver, or otherwise manipulate content, or enable any of these tasks for a user. In one embodiment, the LMS may utilize contextualization information to provide search results or recommendations of content to a user which are relevant to the user's study area at the time the search was performed. In this embodiment, the user could be a student searching for research materials or a teacher gathering content for a course. In this embodiment, the LMS may use LKU information associated with the course in determining which content to recommend or display to the user.

In one aspect of the preferred embodiment, the LMS provides at least one Contextualization Engine (“CE”) that, in conjunction with other features or capabilities of the LMS, may categorize content with which the Learner or Educator has interacted, including but not limited to by accessing or creating the content. Preferably, the CE may categorize content using at least one LKU. The CE relates content to and enables assessment of a Learner's learning progression at a very granular, personalized level.

The invention addresses long-felt needs and shortfalls in the educational management process.

### DETAILED DESCRIPTION OF THE INVENTION

The present invention is directed to systems and associated methods for contextualizing and managing educational content, developing. In this preferred embodiment, hereinafter the Learning Management System (“LMS”), users are either Learners or Educators. Learners may include any person, entity, or system engaging the invention in a learning capacity. Educators may include teachers, administrative aides, staff, or other persons, entities, and systems with some oversight responsibility over Learners.

The preferred embodiment illustrates implementation of the invention on client-server computing infrastructure. Any computing infrastructure, including but not limited to LAN-based, virtual machine-based, and locally-based infrastructure, is claimed as an equivalent. The preferred embodiment illustrates implementation of the invention using computer and computer program modules. Any system structure performing the inventive functions is claimed as an equivalent, as is any system structure performing substantially the same steps of the claimed methods.

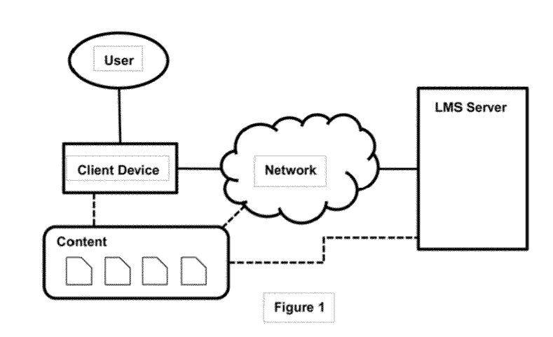

Referring to FIG. 1, in a computing environment in accordance with the invention, the user may interact with the LMS using a client device connected to LMS servers via a network. The network in this embodiment may be the internet, local or wide area network, or other networking infrastructure. The client device may be a general purpose computer such as a personal computer, tablet computer, mobile telephone, or other computer technology comprising at least one processor and memory. The server may be a general purpose computer or computer server, including distributed, remote, and cloud computers, comprising at least one processor and memory.

The processors utilized by the client and server are programmed or structured to carry out the particular tasks and steps described and claimed herein. Some or all of the LKUs, other relevance factors, education content, tags, metadata, Learner data, and other pertinent information may, in one embodiment, be stored on the server in the form of a database. In one embodiment, that information is stored in the form of relational database records corresponding to the content or a content identifier—such as a URL or other resource indicator—to the other information associated with the content. In another embodiment, the other information is stored in metadata attached to or associated with the educational content itself. Non-transitory memory is utilized to enable the processor to perform tasks or steps on any data acquiring in the performance of the described and claimed tasks and steps, and as an intermediary storage medium for the content of the database.

The user may interact with the LMS server using software programs on the client device (“LMS client”), including but not limited to an internet browser plug-in or add-on, installed software programs or applications, remote management software programs, or any other equivalent network communication software program. Preferably, the LMS client may be adapted for real-time communication with the LMS server. Alternatively, the LMS client may be adapted to store data in the client device's memory for later communication with the LMS server. In another embodiment the user may interact with the LMS server directly without using the LMS client using other means, such as directly connecting to the LMS server via the network using an internet browser program, email, FTP program, or other network access protocol. In this embodiment, content may be accessed by the user via any or all of the client device, LMS client, LMS server, or via the network. Content may be accessed by the LMS server via the LMS client, the client device, or via the network. The LMS client and server may require the user to present credentials to log into a user account.

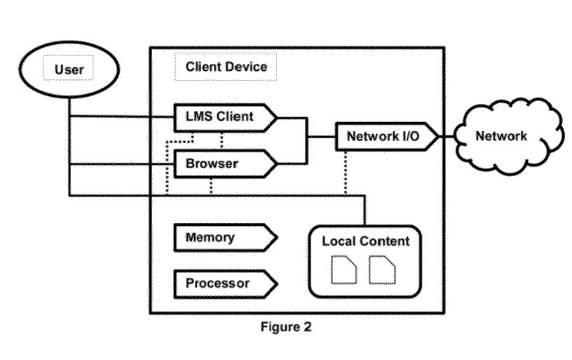

Referring to FIG. 2, the preferred embodiment of the client device is shown. All modules are presumed to be interconnected with one another. Preferably, the user may access the network, network-accessible content, and the LMS server as shown in FIG. 1 via an internet browser or the LMS Client. The LMS Client may access local content, the browser, and the network as shown in FIG. 2. The user may access local content stored on the client device via the client device itself, an internet browser program, the LMS Client, or any equivalent content access program.

In the preferred embodiment, the LMS Client may monitor user actions, including content interactions, on the client device and may transmit data related to such user actions to the LMS server shown in FIG. 1. The LMS Server may analyze the transmitted data and transmit data to the client device.

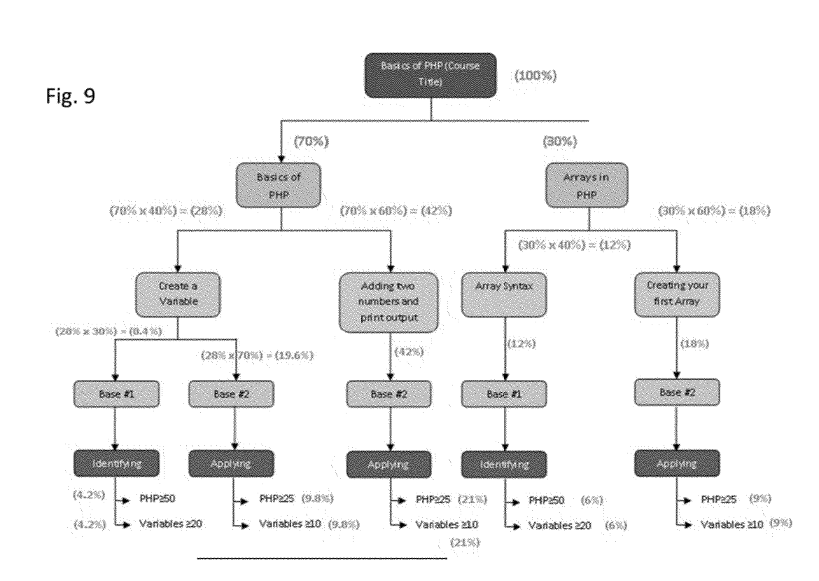

Through use of the LMS, a user may access or create educational content, analyze it and labeled with certain “tags” which could be indicative of certain aspects of the educational relevance of the content, either generally or specific to the particular study area for which the user accesses or creates the content or to himself (if he created it or if he shared it). In this embodiment, the tags may reveal any or all of the standards, bases, and indicators for which the content has educational value. The content thus may be “contextualized,” for its likelihood of relevance in this embodiment by the Contextualization Engine, and given a contextualization score indicating its relationship, including relevancy and weightage (because the collaborative content may be weighed higher, for example), to a study area. In this embodiment, contextualization may be based on the presence or absence of specific tags or LKUs, or other features of the content such as its source, age, or the substance of the content itself, which indicate directly, indirectly, or via some probability that the content is relevant to a study area, standard, base, or indicator. An exemplary weightage scheme is depicted in FIG. 9.

The LMS may utilize contextualization information to validate, time, search for, index, link, rank, sort, highlight, recommend, display, store, deliver, or otherwise manipulate content, or enable any of these tasks for a user. In one embodiment, the LMS may utilize contextualization information to provide search results or recommendations of content to a user which are relevant to the user's study area at the time the search was performed. In this embodiment, the user could be a student searching for research materials or a teacher gathering content for a course. In this embodiment, the LMS may use LKU information associated with the course in determining which content to recommend or display to the user.

The LMS is directed to identifying, categorizing and contextualizing educational content so that it is put at the better disposal of Educators and Learners. “Educational content” or “content” is any information that may contribute to a Learner's learning or mastery of a course or study area. It includes documents, websites, videos, podcasts, textbooks, homework, tests, essays, and other educational or instructional materials or sources of information in any form, electronic, hardcopy or otherwise, to be put to use in instructing or educating a Learner. Sources of content include pre-existing content and generated in the course of a study regimen collaboratively among Educators, or between Educators and Learners.

The LMS may identify, categorize and contextualize educational content in a variety of ways. In the preferred embodiment, educational content is identified, categorized and contextualized in terms of foundational components of varying levels and purposes. Learning experiences consist of one or more courses of study in a particular area, where each course may comprise at least one unit, each of may comprise at least one standard, each of which may comprise at least one base, each of which may be associated with at least one indicator. “Standards” are the units or building blocks of skills needed to be competent within a given course in a study area. For example, in one embodiment, standards established for a math course for elementary algebra may include the standard of “graphing linear equations” or “simplifying expressions.”

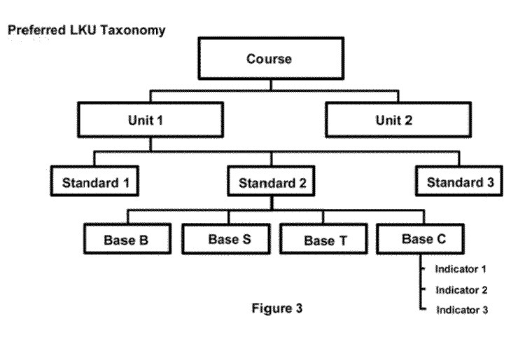

Each standard is comprised of “bases.” Bases represent the educational objectives and elements of competency of a Learner with respect to a particular standard. Bases differ from standards in that bases represent mastery of the subject matter within a standard. Bases can be expressed in any number of ways. In one embodiment, bases represent combinations, summations or higher abstractions of levels drawn from the various configurations of Bloom's taxonomy. Bases may be hierarchical in that some bases may be indicative of a higher level of mastery of a standard's subject matter. However, bases need not be linear. Bases may be cast in any manner that is most suited to the Educator's objectives in conveying competency and master of a standard within a given course. In one embodiment, there may be four bases, as illustrated in FIG. 3: Base B (base declarative knowledge); Base S (skills & proficiencies); Base T (thinking critically); and Base C (creative thinking). Here, each standard comprises these four bases as they represent a Learner's mastery of elements or building blocks of a particular standard.

Preferably, bases may be categorized or defined by at least one indicator, which provides a reference for assessing a Learner's competency of that base. “Indicators” describe the particular educational tasks that are relevant to the user fulfilling the requirements of bases within the standards associated with the user's study area. In one exemplary embodiment, in a Latin language course, indicators for Base B (declarative knowledge) may include “describing,” “observing,” or “organizing,” while indicators for Base T may include “analyzing” and “structuring.” An indicator may be an assessment of the particular skill associated with the base and, in one embodiment, may be drawn from elemental levels of Bloom's taxonomy. In one embodiment, indicators may be allocated to bases by recommendation and selection from an existing store of indicators; alternatively, new indicators may be created for a base. As indicators themselves have value to Educators, one embodiment of the invention provides for the generation and storage of indicator packages keyed to study areas, units, standards, and bases. Thus, educational content characterized, identified or contextualized by finite elements placed in a particular hierarchy allow the Educator and Learner to readily assess the contribution of educational content to the goals of a course in a study area.

These finite elements of standards, bases and indicators may be used to generate a LKU associated with courses, units, standards, bases or other aspects of a study area to identify the component parts of educational content. An LKU is an encoded representation of educational content associating it with at least one course, unit, standard, base, and indicator, or any other metadata tag, whether provided by a third party or not. LKUs may be acquired or accessed externally or generated by the systems of the present invention. LKUs categorize content into at least one study area, unit, standard, base, or indicator. LKUs may include other tags or metadata, including tags and metadata personalized to or for a particular Educator or Learner, such as, by way of example but not limitation, information related to a Learner's interactions with the content, time spent by the Learner in accessing and interacting with the content and the extent to which the content is used to generate new content. Thus, an Educator or Learner, using the LMS, may categorize or contextualize content by associating one or more LKUs with the content and help gauge its relevance and potential contribution to the learning experience. Moreover, the more LKUs are associated with certain education content the more likely the relevance, usefulness and mastery of the content can be accurately assessed. LKUs may be time tagged and they provide the data for statistics-including but not limited to the total time, active time, collaborative time—used by the LMS to generate a user's competency score.

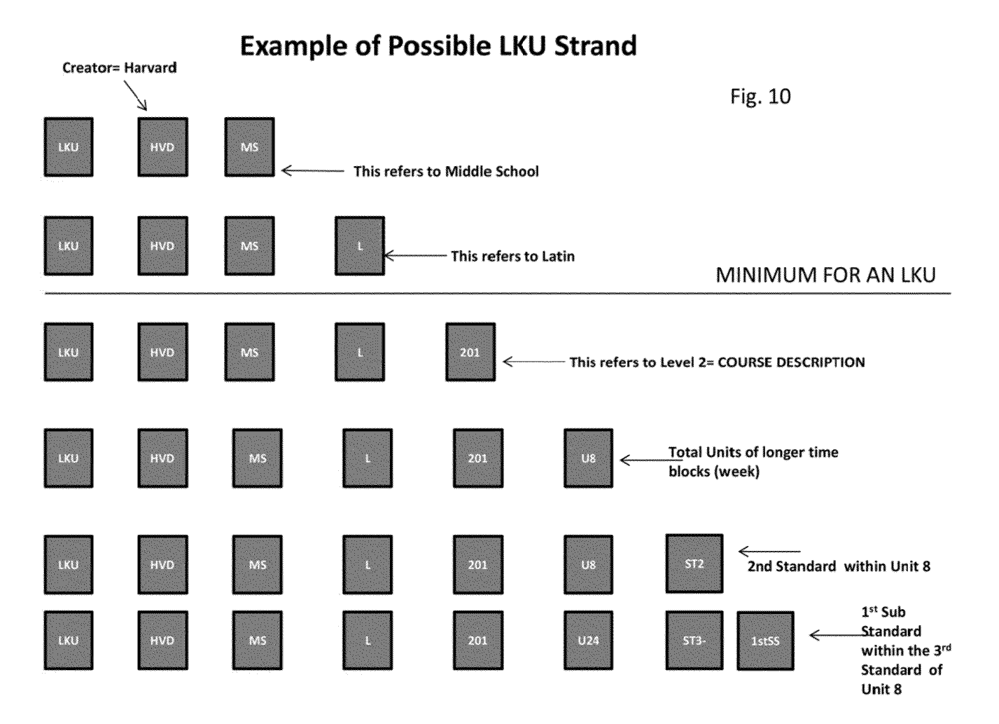

Each LKU has a static profile and a dynamic profile. As more use of an LKU is made, more information is generated, while retaining identification as to its lineage and related LKUs through the sequence similarities shared among LKUs. The LKUs may be structured as strands of separate units or “codons” of information, as illustrated in FIG. 10. In this embodiment, the LKUs are stored in a database along with either the content itself or resource locators pointing to the content. This system and associated method enables Educators and Learners to rapidly access relevant content based on LKUs associated with their current learning situation, and to assign LKUs to content they access or create.

In one embodiment, the LMS and its methods use LKUs to identify, categorize and contextualize educational content. Through use of LKU approach, the LMS provides a more granular measure of a Learner's mastery of particular content and enables communication between users as to Learner progress, course composition, and the pedigree of the content accessed. Such a system and method enables Educators to discern with high accuracy the learning history of each Learner, including which institution provided her coursework.

In this embodiment, the LMS Client may scan content for LKUs and other LMS functionality. The LMS client may implement LMS functionality, such as tagging content, i.e., assigning LKUs to the content. This data may be processed locally or transmitted to the LMS server for processing.

In an instance in which the user is a Learner, the user may access the LMS Server, Learner dashboard, and other LMS functionality via the internet browser, LMS Client, or equivalent network access program. The Learner then may utilize LMS functionality such as the contextualized search and competency functions while working in a study area.

In one exemplary embodiment, a Learner may access the LMS via the LMS Client and receive an assignment. The assignment may have been associated with certain LKUs by the LMS server or alternatively by an Educator. These LKUs may provide context for the LMS client and the Learner to focus the Learner's learning activities. In this exemplary embodiment, the Learner may use the LMS Client, including in conjunction with a search engine, including the LMS Search Engine, to conduct research for the assignment. The LKUs may contextually focus search results and may recommend or rank particular content over other content as more relevant to the Learner's search in light of the LKUs. The LMS may recommend or rank particular content as more relevant in light of the Learner's competency of the relevant subject matters, as assessed by the LMS, the Educator or the Learner. In this sense, the LMS may recommend or rank content that it may determine is more relevant to the particular Learner, delivering personalized content based on the Learner's individual learning history and learning affinities and the sequence of content that the LMS may determine is most appropriate based on analysis of other students' performance in the same LKU set.

To illustrate the above embodiment, a Learner accesses LMS and receives a research assignment on the causes of World War I. The assignment is an assessment of the Learner's competency in Base “X” of Standard “Y” within a study area. The Learner searches for content on this topic using a search engine. The LMS recommends content that may be directly related to Base “X” by recognizing LKU tags associated with that content which indicate to the LMS that the content is related to the unit of the subject course. In this example, the content may pertain to the Austrian invasion of Serbia. The LMS also recommends content that may be indirectly related based on Base and Standard sequencing optimization information determined by the LMS or an Educator—here, the assassination of Archduke Franz Ferdinand, which is information determined to be highly correlated with competency in the present issue.

In an instance in which the user is an Educator, the user may access the LMS server, Educator dashboard, and other LMS functionality via the internet browser, LMS client, or equivalent network access program. In this instance, the Educator user then may utilize LMS functionality, including but not limited to managing standards, bases, and indicators for a study area; designing courses; searching for contextualized content; contextualizing or curating and tagging content; developing assessment tools; managing the competency engine; viewing statistics and validation information; and other LMS functionality.

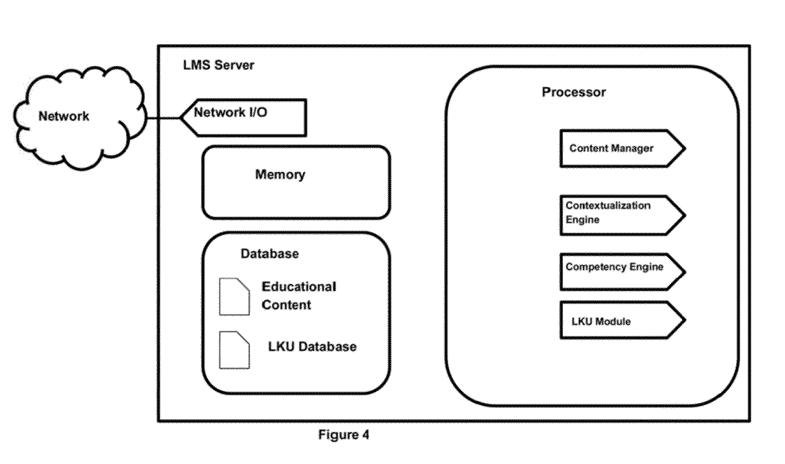

Referring to FIG. 4, the preferred embodiment of the LMS Server is shown. All modules are presumed to be interconnected with one another, and may be physically or logically distinct or structured in a functionally equivalent manner. The list of modules is not exclusive or exhaustive and is intended to represent one embodiment only. These figures are intended as high-level technical architectural representations of an embodiment of the invention. Preferably, the LMS Server may receive and transmit data via its network access tools. In the preferred embodiment, the LMS Server may use said network access tools to access the internet or other network from which the LMS Server may access the Client Device and content as illustrated in FIGS. 1 and 2.

### Content Manager

The LMS provides at least one Content Manager (CM). The CM may receive and transmit data between the LMS Server and the network, and to and from the other modules. The CM may capture content that the user or LMS client transmits to the LMS Server.

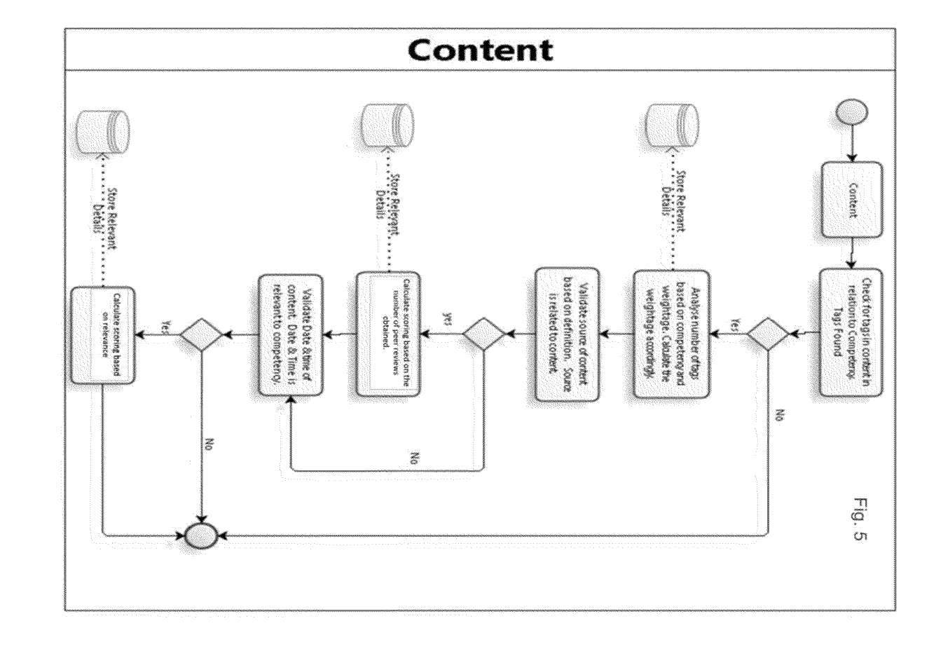

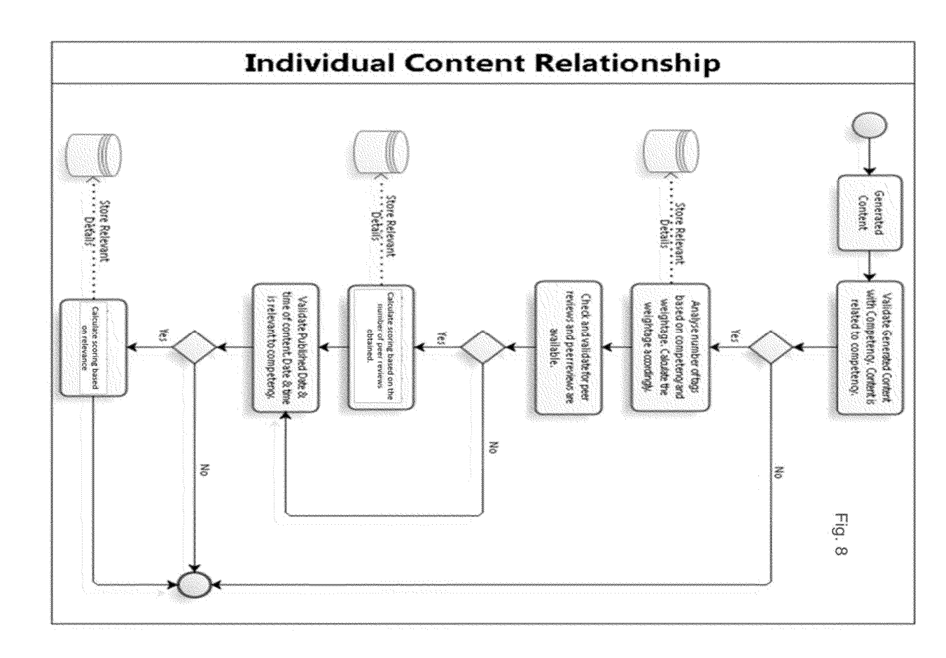

In this embodiment, as depicted in the flowcharts in FIG. 5 and FIG. 8, the CM, in conjunction with other LMS Server modules, may tag and score content with LKUs. These LKUs may be stored in a database in the LMS server memory, another database available via the network, stored within the content as metadata, or acquired elsewhere. These tags may provide context for the content in relation to a study area. For instance, if a Learner accesses new content during her search related to the causes of World War 1, and that content is transmitted by the LMS Client to the CM, the CM may tag that content with an LKU associating it with Base “X” of Standard “Y” as in the above example. The CM may score the content as highly relevant if the Learner spends significant time accessing the content or if the content is cited frequently in the assignment.

The CM, in conjunction with other modules, may also encode the LKUs for particular educational content with elements related to the Learner's learning progression, such as the amount of time spent accessing the content, the fact of access, and other relevant information including the potentially the place of access utilizing GPS capability on enabled devices or computing school hours and relating it to time of tagging. These added elements may provide for assessing a Learner's competency, and may be used in analyzing content created by the Learner, such as an essay.

The CM may read or access tags added by an outside entity.

### Contextualization Engine

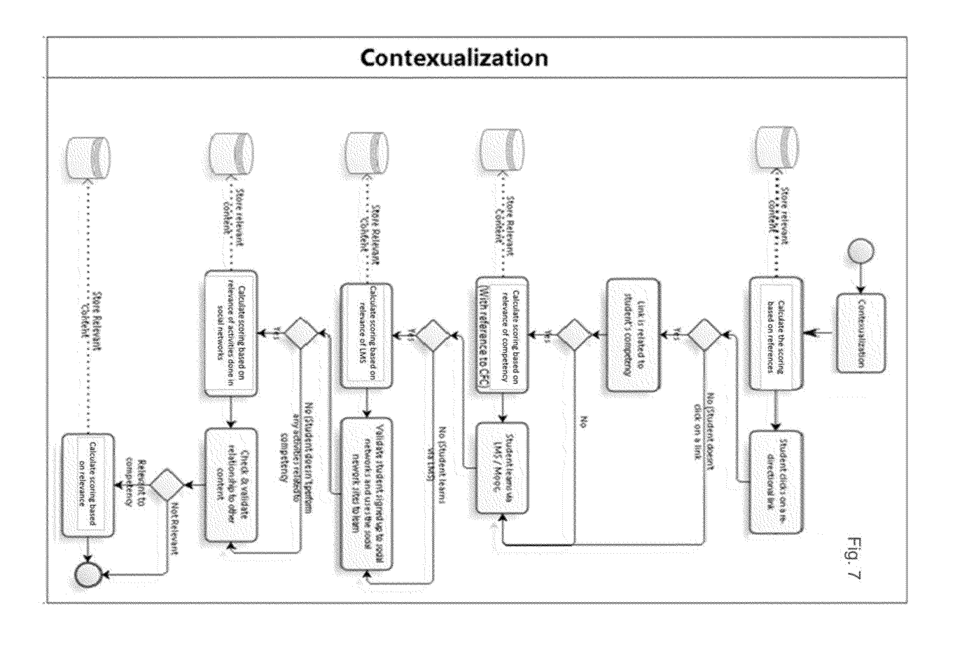

In one aspect of the preferred embodiment, the LMS provides at least one Contextualization Engine (“CE”). As depicted in FIG. 7, The CE, in conjunction with other LMS modules, may rank, contextualize, categorize, i.e., score educational content with which the Learner or Educator has interacted in relation to the standards or bases applicable to a particular course or study area. Preferably, the CE may score content using at least one LKU. The CE scores and categorizes educational in relation to a Learner's learning progression at a very granular, personalized level. The more LKUs the more accurate the score and, thus, the more likelihood the score assesses the relevance of the educational content.

A course of study may be defined by a set of standards and bases as a guide or measure of mastery or competency of said course of study by a Learner. The CE may be employed to score, that is to rank, contextualize or categorize, educational content. Scoring may be based on the presence or absence of specific LKUs, or other features of the content such as its source, age, or the substance of the content itself, which indicate directly, indirectly, or via some probability that the content is relevant to a Learner's course or study area. By way of example, the LMS may determine that particular educational content has a high score because the LKUs associated with the content, as well as other features of the content discussed above, when algorithmically compared to the standards and bases for the course or study area show a high degree of correspondence. Other validated contextualization operations may also be used to generate a score for educational content based on its associated LKUs and the particular study area. Generally, any algorithm for scoring can be devised by an Educator or Learner, or other skilled artisan, to measure, for the user's purpose, the relevance or usefulness of the educational content in a course or study area by the degree to which one or more LKUs associated with the educational content correspond to the standards or bases of that course or study area. In this example, a biology unit on “ducks” might have the word “duck” in the tagging dictionary for that unit but if the learner came across the sentence “duck for cover” in a content item, for instance an article from the National Rifle Association, that item may not be relevant to the biology unit. The CE, here, would look at the probability of the item's relevance by looking at other tags that it has determined are related to biology, as well as other information such as the source of the content.

The CE may ascertain relevance by determining the frequency or extent of relevance in similar situations historically, and suggest that content may be relevant based on the historically-derived probability that the content is relevant to this particular Learner in this particular learning context, based on attributes of the content and the Learner. In one embodiment, the CE could assess that content associated with one or more LKUs is relevant to a Learner studying biology because the content positively contributed to the competency of nine out of ten similarly situated past Learners, or because it has many similar tags as content that has done so, or was accessed for an extensive amount of time by such learners indicating they found it useful, or was very new, or was derived from a source known to be authoritative in the relevant subject area. A combination of these or equivalent factors, or other factors, may be considered by the CE to determine relevance.

Educational content, which meet thresholds for relevance via probabilistic algorithms, may be determined to be relevant and thus suggested as content to include in a coursework package or used to determine a Learner's competency in the areas the content is relevant. Based on a Learner's later competency score, the LMS may validate the contextualization algorithm and its component parts, as well as the prior outcomes of the algorithm—that is, previous contextualization decisions. In the previous example, if the Learner accessed content titled “History of Ducks,” the content was contextualized as related to the Biology unit, and the Learner was later judged highly competent in Biology after accessing “History of Ducks,” the LMS may validate the contextualization of “History of Ducks” as being related to Biology. In another example, if the Learner only accessed content from Yale University, and was later judged not competent in Biology, the LMS may adjust the algorithm to assign a lesser weight to Yale as a source of Biology-relevant content. This validation procedure may be applied to any contextualization input factor. The contextualization score for the content as per its associated LKUs may be updated to reflect changes resulting from validation. Thus, the population of LKUs associated with educational content may change dynamically over time as contextualization is refined based on the validated success of Learners interacting with the content. The LMS may update its database or metadata tags to reflect validation.

The relevance of educational content may be calculated, that is, a contextualization score may be derived for that content, via any of the content scoring algorithms known in the art. In one exemplary embodiment, the contextualization score may be calculated in accordance with the following content competency calculation (CCC):
i. Calculate the accumulated score for each of the CCC components (Tags Acquired, Date, Source, Analytic Content, Relationship to other Content, Learning Environment, Social Content, Generated Content, Peer Reviews and Date & Time) using the following formula.

Aggregate Component Score=5×[1−EXP(−0.00438×ΣSᵢ)]
The score would have a minimum value of 0 (when no aggregate score has been acquired)
The score would have a maximum value of 5 (hypothetically, when approximately an aggregate score of 2,000 been acquired)
The “beta” factor (β) for the formula stands at −0.00438 (which can be amended as per the need).
The “alpha” factor (α) for the formula stands at 1 (which can be amended as per the need).
   Prior to the calculation of “step ii” below, for the “Contents” component of the CCC, apply the following weights to obtain the final score for the Tags, Date and Source parameters as follows.
Multiply the “Tag” score in step “i” above by the weight 0.8 to obtain (Sᵢ)
Multiply the “Date” score in step “i” above by the weight 0.1 to obtain (S₂)
Multiply the “Source” score in step “i” above by the weight 0.1 to obtain (S₃)
ii. Calculate the weighted score for each of the components of the Contents, Contextualization and Individual Content Relationships using the following formula.

Formula for weighted score (Pᵢ)=(Sᵢ/ΣSᵢ)

For example, if the combined score for the “Tags Acquired” on the articles read, “Date of article” and “Source of the Article” are assumed as S₁, S₂ and S₃ in step “i” above respectively, the weighted score of “Tags Acquired” (P₁) is obtained as follows.

Weighted Score for Tags Acquired (P₁)={S₁/(S₁+S₂+S₃)}

Similarly if the “Date” and “Source” scores are assumed as P₂ and P₃ respectively, those scores are derived as follows.

Weighted Score for Content Date (P₂)={S₂/(S₁+S₂+S₃)}

Weighted Score for Tags Acquired (P₃)={S₃/(S₁+S₂+S₃)}
iii. Calculate the aggregate score for each of the components of the CCC, i.e. Content, Contextualization and Individual Content Relationships as follows.

Formula for aggregated score (Cᵢ)=−Σ(Pᵢ×log₂ Pᵢ)

For example, if the aggregate score for the “Content” area is identified as (C₁) the aggregate score is calculated as follows.

Formula for Aggregate Content Score (C₁)=−Σ(P₁×log₂ P₁)−Σ(P₂×log₂ P₂)−Σ(P₃×log₂ P₃)

Similarly if the “Contextualization” and “Individual Content Relationships” aggregate scores are assumed as C₂ and C₃ respectively, those scores are derived as same as above in step 2.
iv. Calculate the weighted average scores for the aggregate score of Content, Contextualization and Individual Content Relationships as follows.

Weighted Score for Content (Pₓ)={P₁/(P₁+P₂+P₃)}

Weighted Score for Contextualization (P_{y})={P₁/(P₁+P₂+P₃)}

Weighted Score for Individual Content Relationship (P_{z})={P₁/(P₁+P₂+P₃)}
v. Calculate the finalized score for CCC using the same formula as in “step ii” of the process.

Aggregate CCC score=−Σ(Pₓ×log₂ Pₓ)−Σ(P_{y}×log₂ P_{y})−Σ(P_{z}×log₂ P_{z})

In one embodiment, the CE may capture and store information related the total amount of time a Learner accesses content as well as the amount of time the Learner actively engages the content. The Learner may receive “credit” towards her Competency Score for the standards or bases encoded by the LKUs associated with that content, based on the time spent interacting with the content and rules established by the Educator. In one embodiment, the timing information may be provided by the LMS Client. In this embodiment, an LMS Client may record a Learner spending 15 minutes reading a Latin dictionary from a notable website, which has been tagged with an LKU referencing its relevance to Base B of Standard 1 in a Latin language course. The LMS Client may transmit this data to the LMS Server, where the Content Manager may capture the tags and transmit to the CE. The CE identifies that the content relates to Base B of Standard 1 and may transmit that information along with the timing data to the Competency Engine.

In another embodiment, a Learner may write an essay for the Latin course, which the LMS Client transmits to the LMS Server. The CM may index or otherwise prepare the essay for analysis by the CE. The CE may read the essay, identify relevant key terms, concepts, and usage of grammar rules as determined by the LKUs associated with the essay. The CE may contextualize the essay as relevant to Base T of Standard 1 based on rules established by the Educator. The CE may transmit this information to the Competency Engine for assessment.

1. A method comprising the steps of:
Acquiring educational content pertaining to a course or study area of a learner thereof, which course or study area is characterized by or associated with standards and bases;
Scoring the educational content for relevance to or usefulness in said course or study area using one or more LKUs associated with said educational content and said standards or bases of that course or study area;
Storing the result of said scoring in a database.

2. The method of claim 1 further comprising storing the educational content in at least one database.

3. The method of claim 1, further comprising the steps of:
Querying said database with at least one reference LKU;
Comparing said at least one LKU with the LKUs of said associations stored in said database;
Returning those associations responsive to the query.

4. The method of claim 1 wherein said score expresses aspects of said educational relevance in reference to at least one learner.

5. The method of claim 1 wherein said score expresses aspects of said educational relevance in reference to at least one course of study.

6. The method of claim 4 further comprising the steps of:
Determining a change in competency of said at least one learner;
Determining a contribution of said content to said change in competency;
Validating said educational relevance in reference to said contribution of said content to said change in competency;
Updating said scoring based on said validation;
Storing the updated scoring result in said database.

7. The method of claim 5 further comprising the steps of:
Determining an aggregated change in competency of a plurality of learners exposed to said course of study;
Determining a contribution of said content to said aggregated change in competency;
Validating said educational relevance in reference to said contribution of said content to said aggregated change in competency;
Updating said scoring based on said validation;
Storing the updated scoring result in said database.

8. The method of claim 1 wherein at least one LKU associated with said educational content contains one or more elements of personalized information regarding the learner's past interaction with the educational content.

9. A method, comprising the steps of:
Generating an LKU for educational content;
Associating said LKU with said educational content;
Storing said association.

10. The method of claim 9 wherein said association is stored in a database.

11. The method of claim 9 wherein said association is stored in a content metadata tag.

12. The method of claim 9 further comprising updating an LKU associated with the educational content and storing said updated LKU.

13. The method of claim 9 wherein at least one LKU associated with said educational content contains one or more elements of personalized information regarding the learner's past interaction with the educational content.

14. A system, comprising:
Non-transitory memory comprising a database for storing educational content; and
At least one processor, wherein said at least one processor is programmed or structured to:
Acquire educational content pertaining to a course or study area of a learner thereof, which course or study area is characterized by or associated with certain standards and bases;
Score the educational content for relevance to or usefulness in a course or study area using said one or more LKUs and said standards or bases;
Store the result of said scoring in said database.

15. The system of claim 14 wherein said processor is further programmed or structured to store the educational content in at least one database;

16. The system of claim 14 wherein said processor is further programmed or structured to:
Query said database with at least one reference LKU;
Compare said at least one LKU with the LKUs of said associations stored in said database;
Return those associations responsive to the query.

17. The system of claim 14 wherein at least one LKU associated with said education content contains one or more elements of personalized information regarding the learner's past interaction with the education content

18. The system of claim 14 wherein said at least one processor acquires educational content from at least one user's at least one client device.

19. The system of claim 14 wherein said at least one processor acquires educational content from at least one network-accessible information storage location.

20. The system of claim 14 wherein said at least one processor comprises at least one content manager, wherein said content manager is programmed or structured to transmit, receive, store, and manipulate educational content.

21. The system of claim 14 wherein said score expresses aspects of said educational relevance in reference to at least one learner.

22. The system of claim 14 wherein said contextualization score expresses aspects of said educational relevance in reference to at least one course of study.

23. The system of claim 21 wherein said processor is further programmed or structured to:
Determine a change in competency of said at least one learner;
Determine a contribution of said content to said change in competency;
Validate said educational relevance in reference to said contribution of said content to said change in competency;
Update said scoring based on said validation;
Store the updated scoring result in said database.

24. The system of claim 22 wherein said processor is further programmed or structured to:
Determine an aggregated change in competency of a plurality of learners exposed to said course of study;
Determine a contribution of said content to said aggregated change in competency;
Validate said educational relevance in reference to said contribution of said content to said aggregated change in competency;
Update said scoring based on said validation;
Store the updated scoring result in said database.

25. A system, comprising:
Non-transitory memory comprising a database for storing educational content; and
At least one processor, wherein said at least one processor is programmed or structured to:
Generate an LKU for educational content;
Associate said LKU with said educational content;
Store said association.

26. The system of claim 25 wherein said association is stored in a database.

27. The system of claim 25 wherein said association is stored in a content metadata tag.

28. The system of claim 25 wherein said processor is further programmed or structured to update an LKU associated with the educational content and storing said updated LKU.

29. The system of claim 25 wherein at least one LKU associated with said education content contains one or more elements of personalized information regarding the learner's past interaction with the education content

30. An LKU comprising an encoded representation of educational relevance for educational content, whereby said educational relevance of said content is represented in a sequence of subparts.

31. The LKU of claim 30 wherein at least one of said subparts comprise metadata tags.

32. The LKU of claim 30 wherein said subparts comprise standards, and bases.
